(19) United States
(12) Patent Application Publication
(10) Pub. No.: US 2013/0140462 A1
(43) Pub. Date: Jun. 6, 2013

(54) DETECTING SURFACE STAINS USING HIGH ABSORBANCE SPECTRAL REGIONS IN THE MID-IR

(71) Applicants: Michael L. Myrick, Columbia, SC (US); Megan R. Pearl, The Woodlands, TX (US); Heather Brooke, Hoboken, NJ (US); Stephen L. Morgan, Columbia, SC (US); Jessica N. McCutcheon, Scranton, SC (US)

(72) Inventors: Michael L. Myrick, Columbia, SC (US); Megan R. Pearl, The Woodlands, TX (US); Heather Brooke, Hoboken, NJ (US); Stephen L. Morgan, Columbia, SC (US); Jessica N. McCutcheon, Scranton, SC (US)

(21) Appl. No.: 13/695,831

(22) PCT Filed: May 4, 2011
(86) PCT No.: PCT/US11/35149

§ 371 Date: Feb. 22, 2013

Related U.S. Application Data
(60) Provisional application No. 61/343,798, filed on May 4, 2010.
(60) Provisional application No. 61/343,798, filed on May 4, 2010.

(51) Int. Cl. G01J 3/42

(52) U.S. Cl. CPC G01J 3/42
USPC 250/341.8; 250/338.1

(57) ABSTRACT

Methods and systems for detecting the presence of a substance on a surface are provided. The method can include directing a modulated light beam (e.g., having a wavelength of about 3 to about 20 μm) from a light source to a beam expander such that the beam expander widens the diameter of the light beam into an expanded beam. The expanded beam can then be directed onto the surface to form an illuminated area. A specular reflection can then be detected from the illuminated area on the surface in each light cycle, and the presence of the substance on the surface can be determined.

### PRIORITY INFORMATION

The present application claims priority to U.S. Provisional Patent Application Ser. No. 61/343,798 filed on May 4, 2010 titled “Detecting Surface Stains Using High Absorbance Spectral Regions in the Mid-IR” of Myrick, et al. and U.S. Provisional Patent Application Ser. No. 61/343,799 filed on May 4, 2010 titled “Detecting Heat Capacity Changes Due to Surface Inconsistencies Using High Absorbance Spectral Regions in the Mid-IR” of Myrick, et al., both of which are incorporated by reference herein.

### GOVERNMENT SUPPORT CLAUSE

This invention was made with government support under 2007-DN-BX-K199 awarded by National Institute of Justice/DOJ. Therefore, the government has certain rights in the invention.

### BACKGROUND

Forensic analysis involves the observation and identification of an object that may exist in part or in its entirety on some sort of supporting surface. To do so with a high degree of specificity and discrimination from possible variations of the sample is essential. Examples of forensic samples include, but are not limited to, fingerprints, gunshot residues, questioned documents, condom lubricants, multi-layer paint chips, fibers, ink samples and thin layer chromatography plates.

The quality of a forensic analysis is critical in making the association of evidence as unambiguous as possible, thereby providing compelling identifications and linkages. In many cases, such as with fingerprints, this identification has widely accepted requirements where as in others, such as fiber characterization and comparison, the uniqueness of the results can be disputed. Even the most unique and definitive identification of biological evidence based on genetic information has been successfully questioned and removed as compelling evidence. Minimizing the subjective components or features of a forensic analysis to make compelling identifications and linkages therefore becomes a critical aspect of all forensic analysis. Doing so quickly and in a cost effective manner is equally important.

Advances in science and technology have enabled many new approaches to sample analysis, bringing forensic science into an era which goes far beyond the classic perception of an investigator looking thru a magnifying glass for small traces of evidence. Numerous techniques exist that allow detailed chemical and elemental identification. This includes most all analytical chemistry methods, such as mass spectroscopy, x-ray analysis, scanning electron microscopy and chromatography, that are widely used today to characterize gaseous, liquid and solid materials. Many of these methods are extremely sensitive and require finite material for their use that is consumed as part of the analysis process. Advances in the sensitivity of analytical chemistry methods and instruments over the years have reduced this problem but these methods are still not considered non-destructive. This becomes increasingly important as smaller and smaller pieces of pieces of evidence are examined and required in forensic analysis.

Optical spectroscopy is a type of detection and analysis method that need not destroy a sample and that can often be chemically specific. Infrared (reflection or transmission) spectroscopy, Raman spectroscopy, light polarization spectroscopy and Fourier transform infrared spectroscopy all fall into this category. These techniques carry an advantage in that they can be applied in a non-destructive manner yet obtain rich, detailed information.

Even in view of these recent improvements in forensic detection and analysis, a need exists for improved methods and systems for detecting and identifying the presence of a substance.

### SUMMARY

Objects and advantages of the invention will be set forth in part in the following description, or may be obvious from the description, or may be learned through practice of the invention.

In general, the present disclosure is directed toward methods and systems for detecting the presence of a substance on a surface. For example, the method can include directing a modulated light beam (e.g., having a wavelength of about 3 μm to about 20 μm) from a light source to a beam expander such that the beam expander widens the diameter of the light beam into an expanded beam. The expanded beam can then be directed onto the surface to form an illuminated area. A specular reflection can then be detected from the illuminated area on the surface in each light cycle, and the presence of the substance on the surface can be determined.

In one embodiment, the system can include a light source configured to focus a light beam having a wavelength of about 3 μm to about 20 μm, a beam expander positioned to receive the light beam from the light source and create an expanded beam and illuminate the surface with the expanded beam to form an illuminated area, a modulator configured to pulse the light beam through a light cycle, a sensor focused on the surface and configured to detect a specular reflection from the illuminated area on the surface in each light cycle, and a computing device configured to determine the presence of the substance on the surface.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows an exemplary system for detecting the presence of a substance on a surface; and

FIG. 2 shows an exemplary system for detecting the presence of a substance on a surface.

Repeat use of reference characters in the present specification and drawings is intended to represent the same or analogous features or elements of the present invention.

### DETAILED DESCRIPTION

The following description and other modifications and variations to the present invention may be practiced by those of ordinary skill in the art, without departing from the spirit and scope of the present invention. In addition, it should be understood that aspects of the various embodiments may be interchanged either in whole or in part. Furthermore, those of ordinary skill in the art will appreciate that the following description is by way of example only, and is not intended to limit the invention.

Generally speaking, the present disclosure is directed to systems and methods for detecting surface films, coatings, and/or contaminants in concentrations as low as about 90 ng/cm². This limit of detection could be lowered by optimizing the angles of incidence and detection or averaging over several angles depending on the substrate. Thus, these systems and methods provide a non-destructive, hands-off technique for the detection of surface coatings in trace concentrations, coatings that are often times invisible to the naked eye. One field that would greatly benefit from the presently disclosed systems and methods is that of forensic sciences. One skilled in the art would easily realize possible applications in the forensic sciences include detection of latent prints, gunshot residue, drug contamination, fire and explosives analysis and counterfeit documents—among many others not mentioned here.

The presently disclosed systems and methods use the characteristic of most materials, which absorb strongly in the fundamental IR spectral region (e.g. about 3 to about 20 μm). In regions of fundamental absorbance, the absorption in these bands is so strong that the measured reflectance contains only specular reflection (i.e., reflection that is surface-dominated). Any photons that penetrate the surface are absorbed and, therefore, not re-emitted. While there is only a small change in the spectrum, the specular reflectance changes substantially when a thin surface coating is present.

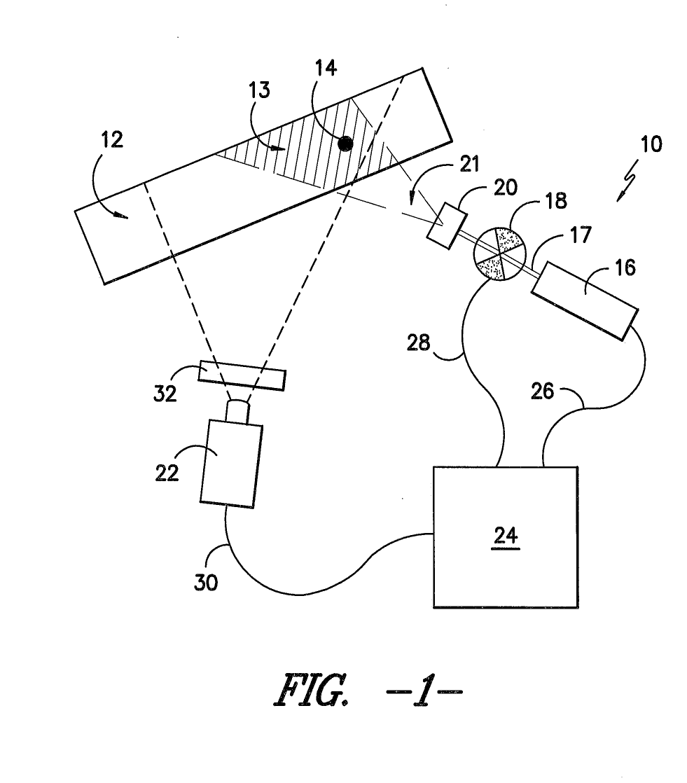

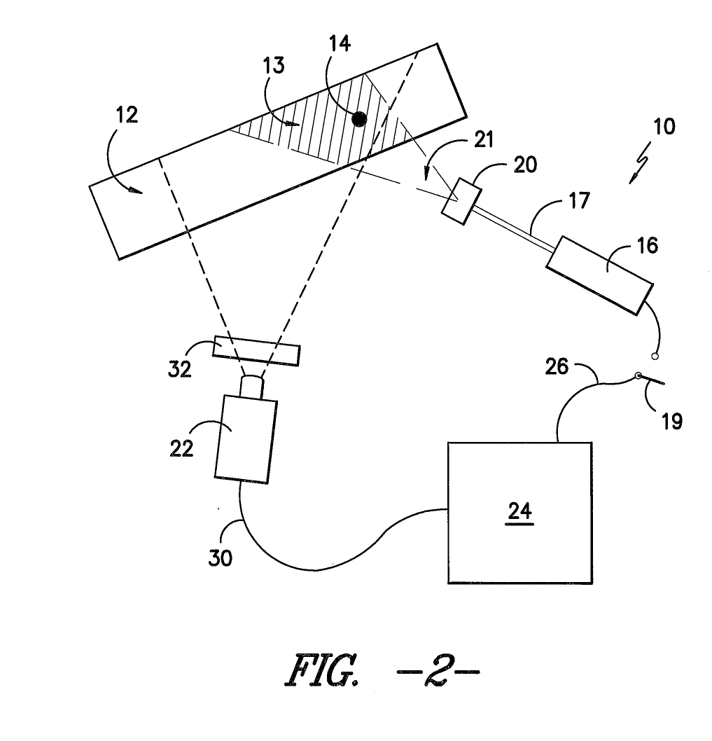

FIGS. 1 and 2 show exemplary systems 10 for detecting the presence of a substance 14 on a surface 12. As shown, the systems 10 include a light source 16 configured to emit a light in the fundamental IR spectral region (e.g. about 3 to about 20 μm), which can be directed toward the surface to be tested. For example, the light source can focus a light beam 17 (e.g., in the form of a laser beam) having a wavelength of about 3 μm to about 20 μm. In one embodiment, the light beam 17 has a range of wavelengths within about 3 μm to about 20 μm. For example, the light beam can encompass an entire spectrum of wavelengths spanning from about 3 μm to about 20 μm. In particular embodiments, the light beam can be substantially free from light having a wavelength of less than 3 μm and/or substantially free from light having a wavelength of greater than 20 μm. In one embodiment, the light source can emit at a relatively high intensity (e.g. about 10 W or more). For example, the light source can emit at about 100 W or more.

An example of a light source that fulfills these criteria is a CO₂ laser source. These lasers are available for low costs and can be obtained with powers exceeding 100 W. One knowledgeable in the art can easily see that any light source meeting the aforementioned criteria can be used, that the instrument is not limited to the use of the CO₂ laser.

A beam expander 20 (expanding optics) is positioned to receive the light beam 17 from the light source 16 and create an expanded beam 21 that illuminates the surface 12 to form an illuminated area 13. In certain embodiments, when coupled with a beam expander 20, the light source 16 could illuminate areas greater than about 2 ft², even as a laser source. Thus, the beam expander 20 can illuminate a relatively large surface area, allowing analysis to be performed simultaneously over the illuminated area 13.

A modulator is coupled with the light source 16 and configured to pulse the light beam 17 through a light cycle at a desired frequency. Any suitable modulator can be utilized to pulse the light beam 17. The frequency of modulation can be varied to control the depth of activation of the layers on the surface 12 in the illuminated area 13.

Generally, the frequency is limited in its upper range by the sampling frequency of the sensor (e.g., the camera or the other detector). If the detection is synchronous with the modulator, the frequency of modulation can be half the frequency of detection. If it is asynchronous, it should be somewhat slower (e.g., generally no faster than about 15 Hz even at a frame rate of about 60 Hz when utilizing a camera). On the low frequency end, the frequency should generally be fast enough that thermal variation in the environment and/or light source is rejected.

For example, in most embodiments, the frequency can be from about 0.1 Hz to about 15 Hz (e.g., about 0.2 Hz to about 10 Hz, such as about 0.5 Hz to about 5 Hz). In one particular embodiment, the frequency can be about 0.8 Hz to about 2.5 Hz (e.g., about 1 Hz).

The light is generally modulated to allow exclusion of the DC component of the detected light, which comes from blackbody radiation from the sample as a result of its temperature. Thus, the detection can be limited to only the AC component. By choosing detection in phase with the modulation, the AC component of the detected light is due to reflectance of the light source from the sample. By choosing detection 90-degrees out of phase with the excitation, the thermal re-emission due to modulation of the sample temperature can be seen as a result of the modulated illumination of the light source. The DC component can be seen as well, if desired. Additionally, modulating the light allows for the selection of a frequency much higher than the natural varying rate of the thermal emission, so that thermal variation effect can be excluded as well. Thus, the AC detection can be performed in-phase and/or out-of-phase which can relate more closely to deeper features of the sample.

FIG. 1 shows that the modulator comprises a chopper 18 positioned between the light source 16 and the surface 12 and configured to mechanically pulse the light beam 17. As shown, the chopper 18 is positioned between the light source 16 and the beam expander 20 to mechanically pulse the light beam 17 prior to being expanded. For example, the chopper 18 defines blades extending therefrom to chop the light beam as the blades rotate around the chopper's center at a controlled speed (e.g., via a motor driven shaft). The light beam 17 is oriented to be mechanically pulsed by the rotating chopper 18 with the blades blocking the light beam then the light beam passing through the gaps. The size of the blades and gaps, along with the speed of rotation (e.g,. at a constant rotation speed), can be adjusted such that the light beam is pulsed at the desired frequency.

FIG. 2 shows that the modulator comprises an electrical switch 19 connected to the light source 16 and configured to electrically pulse the light beam 17 exiting the light source 16. In this embodiment, the electrical switch 19 can be alternated between an “on” and “off” to define the light cycle.

A sensor 22 is shown focused on the surface 12 and configured to detect a specular reflection from the illuminated area 13 on the surface 12 in each light cycle. The criterion for being able to observe surface films/contaminants by this system and method is spectral sensitivity to the specular reflection region of a substrate (i.e., the spectral window in which a substrate reflection contains no Kubelka-Munk reflectance component but only specular or Fresnel reflectance). This is generally in the wavelength range of strong absorbance of the substrate (e.g. a fabric, carpet, paint, etc.), which is from about 3 μm to about 20 μm in most substances. Thus, the systems and methods can include a thermal infrared sensor 22 (e.g., a camera) with a detector sensitive in the long wavelength/deep IR region occupied by fundamental vibrational absorption. One such sensor 22 is an uncooled microbolometer.

A computing device 24 is in communication with the light source 16, the modulator 18 or 19, and/or the camera 22 via connections 26, 28, and 30, respectively (e.g., wired communication, wireless communication, etc.). The computing device 24 is configured to determine the presence of the substance 14 on the surface 12. For example, the computing device 24 can contain computer program instructions stored in a computer readable medium that can direct the computing device 24, other programmable data processing apparatus, or other devices to perform the desired functions in a particular manner. For example, the computing device 24 can include a display (not shown) that replicates an image of the specular reflection detected from the illuminated area 13 from the surface 12.

In particular embodiments, a filter 32 can be positioned between the surface 12 and the sensor 22 to block a specific wavelength or range of wavelengths from reaching the sensor 22. In one embodiment, the filter 32 can be selected to block wavelengths associated with a known substance (e.g., blood). As such, when that substance is on the surface 12, the specular reflection detected by the sensor 22 will be reduced where the substance is located on the surface 12 (i.e., enhancing the background specular reflection from the surface 12 by reducing the specular reflection from the known substance). Thus, the presence of the substance on the surface 12 can be determined. Alternatively, the filter 32 can be selected to block wavelengths associated with the material of the surface 12. As such, when a substance is on that surface 12, the specular reflection detected by the sensor 22 will be reduced in areas surrounding a substance located on the surface 12 (i.e., reducing the background specular reflection from the surface 12 to enhance the specular reflection from a substance on the surface 12). Thus, the presence of the substance on the surface 12 can be determined.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of detecting the presence of a substance on a surface, the method comprising:
directing a light beam having a wavelength of about 3 μm to about 20 μm from a light source to a beam expander, wherein the beam expander widens the diameter of the light beam into an expanded beam;
modulating the light beam to define a light cycle;
directing the expanded beam onto the surface to form an illuminated area;
detecting a specular reflection from the illuminated area on the surface in each light cycle; and
determining the presence of the substance on the surface.

2. The method as in claim 1, further comprising:
filtering the specular reflection from the illuminated area on the surface.

3. The method as in claim 1, wherein the specular reflection are detected using a sensor.

4. The method as in claim 3, wherein the sensor is positioned to detect the specular reflection from the illuminated area on the surface, and wherein the specular reflection is filtered to reduce the specular reflection from the substance.

5. The method as in claim 3, wherein the sensor is positioned to detect the specular reflection from the illuminated area on the surface, and wherein the specular reflection is filtered to reduce the specular reflection from the surface.

6. The method as in claim 1, modulating the light beam comprises chopping the light beam utilizing a chopper wheel.

7. The method as in claim 1, modulating the light beam comprises pulsing the light beam from the light source.

8. The method as in claim 1, wherein the light beam has a range of wavelengths within about 3 μm to about 20 μm.

9. The method as in claim 8, wherein the light beam encompasses an entire spectrum of wavelengths spanning from about 3 μm to about 20 μm.

10. The method as in claim 8, wherein the light beam is substantially free from light having a wavelength of less than 3 μm.

11. The method as in claim 8, wherein the light beam is substantially free from light having a wavelength of greater than 20 μm.

12. The method as in claim 1, wherein the light cycle has a frequency from about 0.1 Hz to about 15 Hz.

13. A system for detecting the presence of a substance on a surface, the system comprising:
a light source configured to focus a light beam having a wavelength of about 3 μm to about 20 μm;
a beam expander positioned to receive the light beam from the light source and create an expanded beam, wherein the beam expander is positioned to illuminate the surface with the expanded beam to form an illuminated area;
a modulator configured to pulse the light beam through a light cycle;
a sensor focused on the surface and configured to detect a specular reflection from the illuminated area on the surface in each light cycle; and
a computing device configured to determine the presence of the substance on the surface.

14. The system as in claim 13, further comprising a light filter positioned between the surface and the sensor such that the specular reflection from the illuminated area can be filtered to prevent certain wavelengths from reaching the sensor.

15. The system as in claim 14, wherein the filter is configured to reduce the specular reflection from the substance.

16. The system as in claim 14, wherein the filter is configured to reduce the specular reflection from the surface.

17. The system as in claim 13, wherein the light beam has a range of wavelengths within about 3 μm to about 20 μm.

18. The system as in claim 13, wherein the modulator comprises a chopper positioned between the light source and the surface and configured to mechanically pulse the light beam.

19. The system as in claim 13, wherein the modulator comprises an electrical switch connected to the light source and configured to electrically pulse the light beam exiting the light source.
